(19) United States
(12) Patent Application Publication
(10) Pub. No.: US 2012/0025431 A1
(43) Pub. Date: Feb. 2, 2012

(54) HIGH-PRESSURE BOTTLE-BLOWING PROCESS AND APPARATUS

(76) Inventor: TAO-CHEN HUANG, Changhua County (TW)

(21) Appl. No.: 12/845,217

(22) Filed: Jul. 28, 2010

(51) Int. Cl. B29C 49/10; B29C 49/30

(52) U.S. Cl. 264/534; 425/525

(57) ABSTRACT

A high-pressure bottle-blowing apparatus performs a high-pressure bottle-blowing process including steps of: a. providing at least one preform to a molding device; b. closing a first mold half and a second mold half of the molding device to form a mold cavity between the first mold half and the second mold half for accommodating the preform therein; c. providing a high-pressure gas to blow and form the preform into a semi-finished container; d. pushing a movable block below the mold cavity toward the mold cavity to indent the semi-finished container and form the semi-finished container with a bottom so as to shape a finished container; e. releasing the finished container from the molding device.

### BACKGROUND OF THE INVENTION

1. Technical Field

The present invention relates to methods and equipment used for high-pressure bottle blowing. More particularly, the present invention relates to a high-pressure bottle-blowing process and apparatus that are applicable to manufacturing of plastic containers, wherein the container such molded has precise threads and a bottom formed with a right-angle or acute-angle connecting rim.

2. Description of Related Art

Cosmetic products retailed, such as nail enamel, mascara and liquid eye liner, are mainly contained in plastic containers made through high-pressure bottle blowing. For example, U.S. Pat. No. 6,059,474 issued to the applicant of the present application has disclosed a multi-purpose nail enamel applicator that incorporates a pen head for drawing and a brush member for painting. The container has a decorative cap sleeved onto its closed bottom end for facilitating its stable stand. In another embodiment of the patent, two said cosmetic containers are connected through a connecting ring so that cosmetic products for different purposes or of different colors can be carried conveniently.

Conventionally, the cosmetic container is formed by blowing a preform under high pressure and high temperature. The preform is to be provided with a threaded end for coupling an upper cap, and an opposite end as the closed bottom end. However, in the traditional manufacturing method, for smooth bottle-blowing process and mold-releasing process, it is difficult to provide the bottom end with threads, and thus the bottom end can only engage the decorative cap or the connecting ring by means of a close-fit or wedge mechanism. As the close-fit or wedge mechanism is limited in providing firm combination, when an external force is applied between the cosmetic containers or between its bottom end and the combined decorative cap or the connecting ring, the close-fit or wedge mechanism tends to be broken and cause uncoupling of the components.

A considerable approach to remedying the problem may be provision thread-based combination between the bottom end of the cosmetic container and the decorative cap or the connecting ring because it is known that thread-based combination is superior to the close-fit or wedge mechanism in engagement. However, the current bottle-blowing process, as mentioned above, only provides one threaded end to a bottle, which is the one for coupling the upper cap and will encounter some problems when trying to form the bottom end with threads. First, when blown and inflated, the bottom end of the preform is unlikely to loyally inherit the shape of the threaded portion on the surface of the mold because the threads of the threaded portion are too fine for the preform to copy the shape through the bottle-molding process. Second, since each of the threads is a depressed part with a sharp point, bubbles may easily exist between the preform and the mode, leading to defective or even absent threads.

In addition, also because of the problem of shaping in the bottle-blowing process and mold-releasing process, the container typically has all its corners and edges formed as a chamfered. This can even highlight the weakness of the close-fit or wedge mechanism because when the bottom end combined with the decorative cap or the connecting ring, the chamfered edge is more likely to slide along and eventually disengage from the decorative cap or the connecting ring under external force, and is less effective in positioning the bottom end as compared with a non-chamfered, square edge.

To sum up, only when the problems about the chamfered edges/corners and the defect and absence of threads from the bottom end are overcome, the firm combination between the components of the container can be ensured.

### SUMMARY OF THE INVENTION

In view of the shortcomings of the prior-at device, the present invention herein provides a high-pressure bottle-blowing process.

According to the present invention, the high-pressure bottle-blowing process comprises steps of:
a. providing at least one preform to a molding device;
b. closing a first mold half and a second mold half of the molding device to form a mold cavity between the first mold half and the second mold half for accommodating the preform therein;
c. providing a high-pressure gas to blow and form the preform into a semi-finished container;
d. pushing a movable block below the mold cavity toward the mold cavity to indent the semi-finished container and form the semi-finished container with a bottom so as to shape a finished container; and
e. releasing the finished container from the molding device.

In the step (d), the movable block is configured to move vertically in a through hole below the mold cavity so that when rising, the movable block pushes the convex bottom upward to work with the high-pressure gas and make the convex bottom partially extend inward the threading groove, so as to provide the semi-finished container with a threaded portion corresponding to the threading groove.

One objective of the present invention is to provide the above-described high-pressure bottle-blowing process, wherein by using the movable block to push the semi-finished container upward, the plastic material is partially pushed backward to form the bottom with a flat surface or a concave surface, so that the bottom is bordered with the periphery of the finished container by a right-angle or acute-angle connecting rim, which allows firmer combination between the components of the container as compared with a container made through he prior-art process.

Another objective of the present invention is to provide the above-described high-pressure bottle-blowing process, wherein by using the movable block to push the semi-finished container upward, the plastic material actually fills the threading groove, so that the threaded portion is formed with evener and more precise threads as compared with a container made through he prior-art process.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is a schematic drawing of a high-pressure bottle-blowing apparatus according to the present invention;

FIG. 2 is a schematic drawing of a molding unit of the present invention;

FIGS. 3 and 4 illustrate motion of the molding unit of the present invention;

FIG. 5 is a partial, enlarged view of FIG. 4;

FIG. 6 also illustrates motion of the molding unit of the present invention; and

FIG. 7 is a partial, enlarged view of FIG. 6.

### DETAILED DESCRIPTION OF THE INVENTION

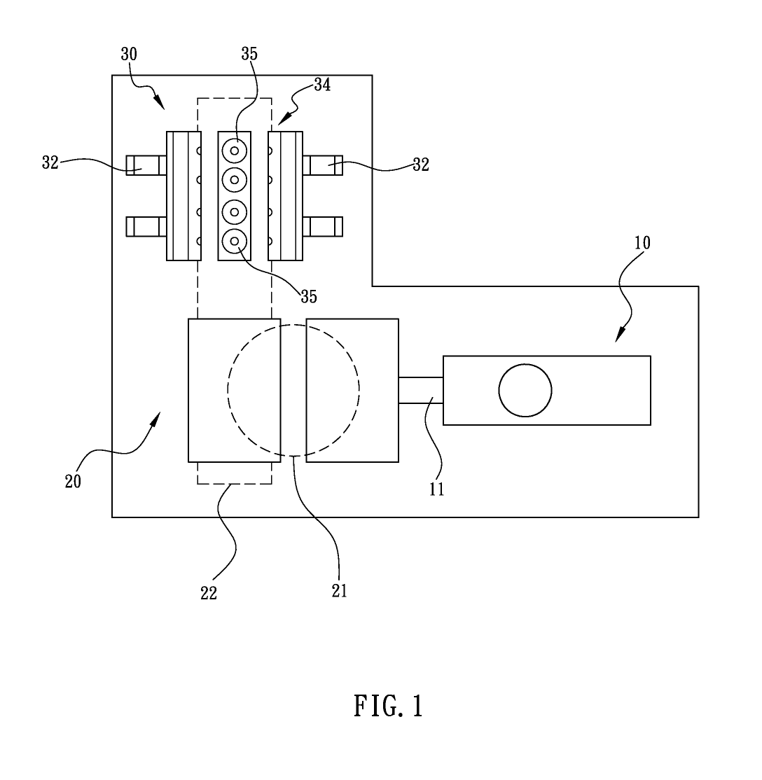

Referring to FIG. 1, a bottle-making machine primarily comprises a material feeding unit 10, a material injecting unit and a molding unit 30. The present invention makes improvement on the molding unit 30 and is applicable to manufacturing of plastic containers made of, for example, PET (Polyethylene terephthalate).

In manufacturing, plastic grains are introduced from the material feeding unit 10 and then heated to become melted by a heating device 11. Then the melted material is delivered to the material injecting unit 20 for making preforms. The preforms 40 are transported by a holding device 21 to an output conveyer 22, and the output conveyer 22 sends the preforms 40 to the molding unit 30 for bottle blowing. The formed preform 40 has a cap-connecting threaded section 41 and a bottle body 42. While the above configuration is illustrated, it is appreciated by people skilled in the art that any of the existing method for making preforms is usable in the present invention. Since the processes for material-feeding, material injection and formation of preforms are known and not features of the present invention, further discussion is omitted herein.

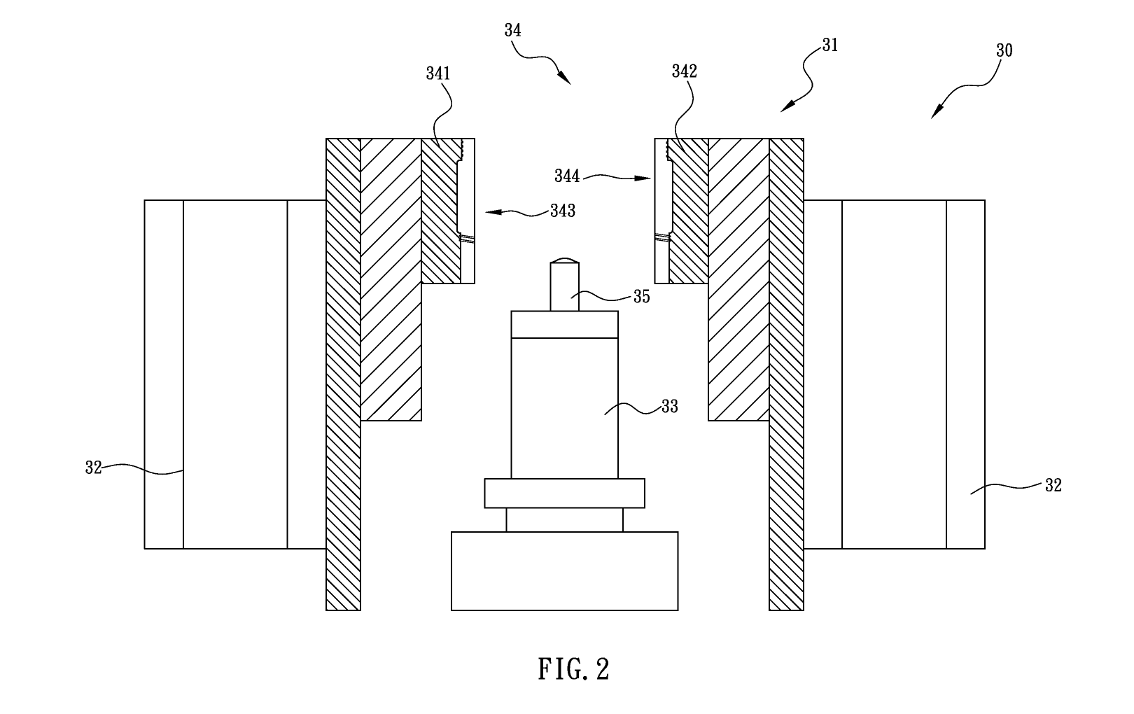

As can be seen in FIG. 1 and FIG. 2, the molding unit 30 includes a molding device 31, a plurality of first power cylinders 32, at least one second power cylinder 33, and a bottle-blowing device (not shown). The molding device 31 comprises a mold set 34 and at least one movable block 35. The mold set 34 is composed of a pair of symmetrical mold halves, namely a first mold half 341 and a second mold half 342. The first mold half 341 and the second mold half 342 are driven by the first power cylinders 32, respectively, so that the first mold half 341 and the second mold half 342 can be drawn together or separated.

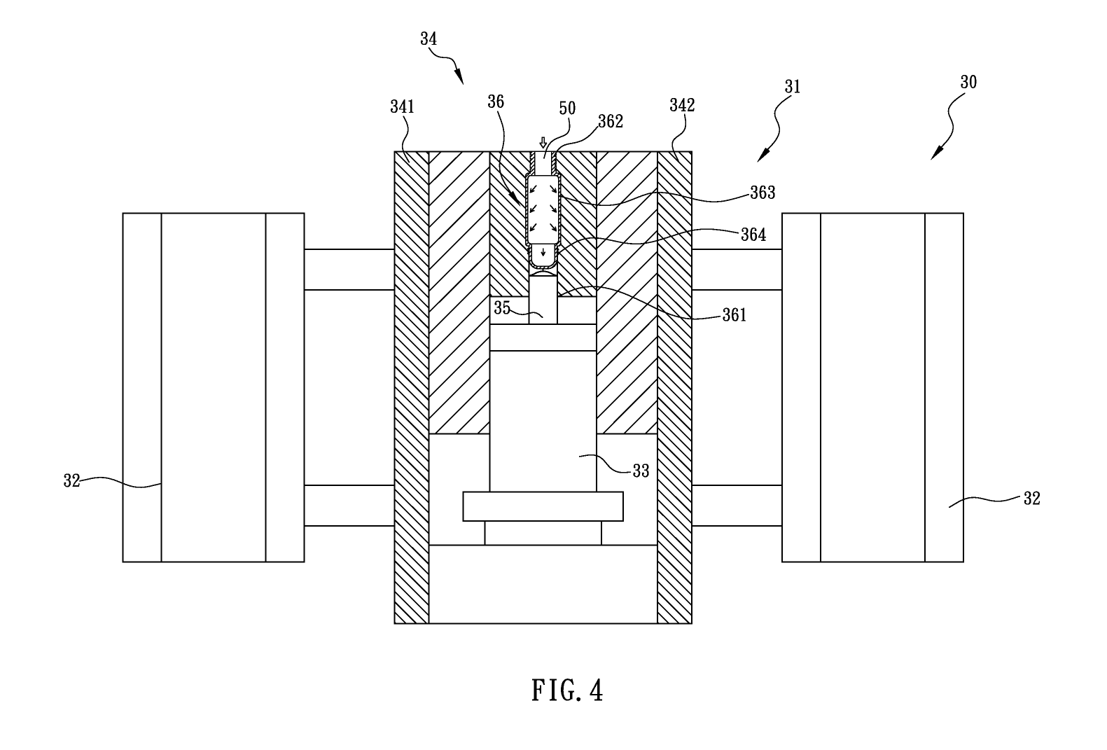

The first mold half 341 has at least one first recess 343 and the second mold half 342 has at least one second recess 344. When the first mold half 341 and the second mold half 342 are drawn together, a mold cavity 36 defined by the first recess 343 and the second recess 344 is formed between the first mold half 341 and the second mold half 342 (as shown in FIG. 4), for accommodating a said preform 40. The mold cavity 36 is communicated to the exterior of the mold set 34 at upper and lower ends thereof. A through hole 361 is formed at the lower end of the mold cavity 36. From its upper end, the mold cavity is formed successively a cap-connecting thread corresponding section 362, a bottle-body receiving section 363 and a thread-forming section 364. The thread-forming section 364 adjacent to the through hole 361 is provided with at least one threading groove 365.

The movable block 35 deposited between the first mold half 341 and the second mold half 342 is driven by the second power cylinder 33 to move vertically in the through hole 361. It is to be noted that the number of the movable block 35 is not limited and only subject to the number of the mold cavity 36. The bottle-blowing device provides a high-pressure gas for performing bottle blowing.

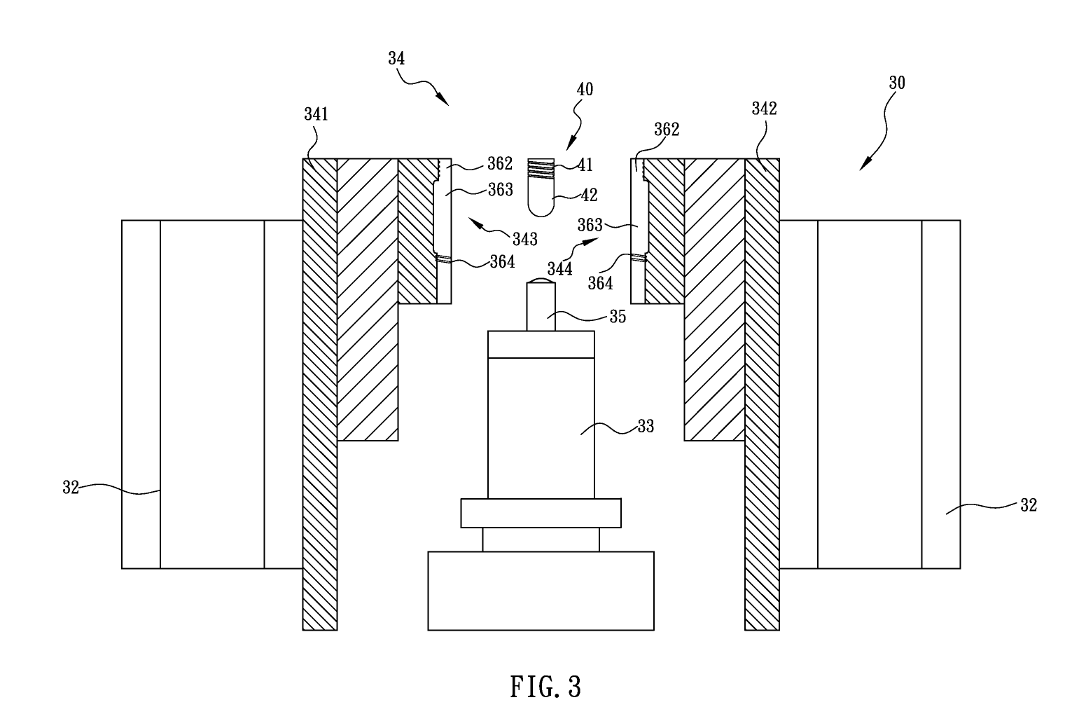

Referring to FIG. 3 and FIG. 4, the preform 40 is set in a preform seat (not shown) and transported to the molding device 31. Afterward, the first mold half 341 and the second mold half 342 are drawn together to such confine the preform 40 in the mold cavity 36 that the cap-connecting threaded section 41 is aligned with the cap-connecting thread corresponding section 362 and the bottle body 42 is aligned with the bottle-body receiving section 363. After the preform 40 is properly positioned, the bottle-blowing device introduces a high-pressure gas into the preform 40 in the mold cavity 36.

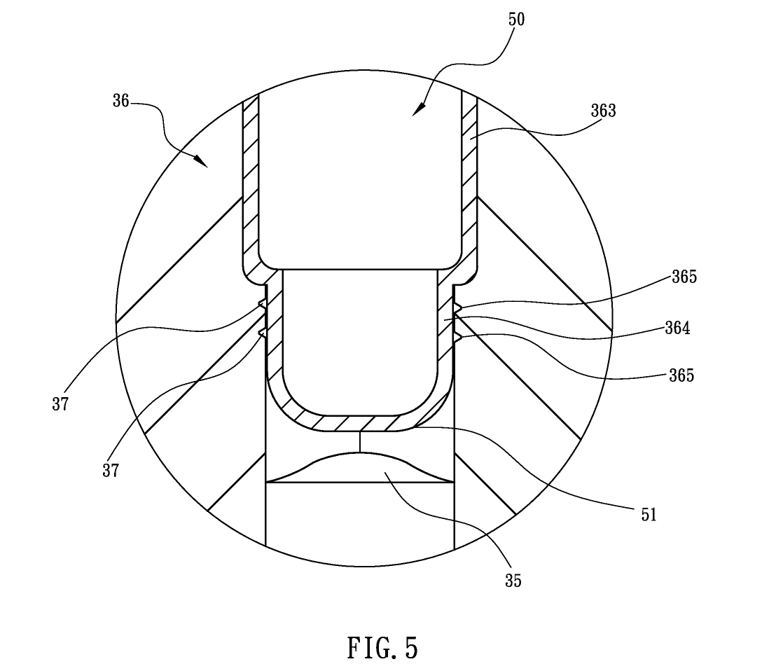

Referring to FIG. 4 and FIG. 5, the preform 40 subject to the high-pressure gas has the bottle body 42 inflated and formed conforming to the profiles of the bottle-body receiving section 363 and the thread-forming section 364 so as to become a container 50 with a convex bottom 51, which is a semi-finished container at this time. Since the high-pressure gas, when reaching the thread-forming section 364, makes the preform 40 inflated directly downward, the threading groove 365 is not fully filled by the material of the preform 40, so that a to-be-filled space 37 is left between the bottle body 42 and the threading groove 365.

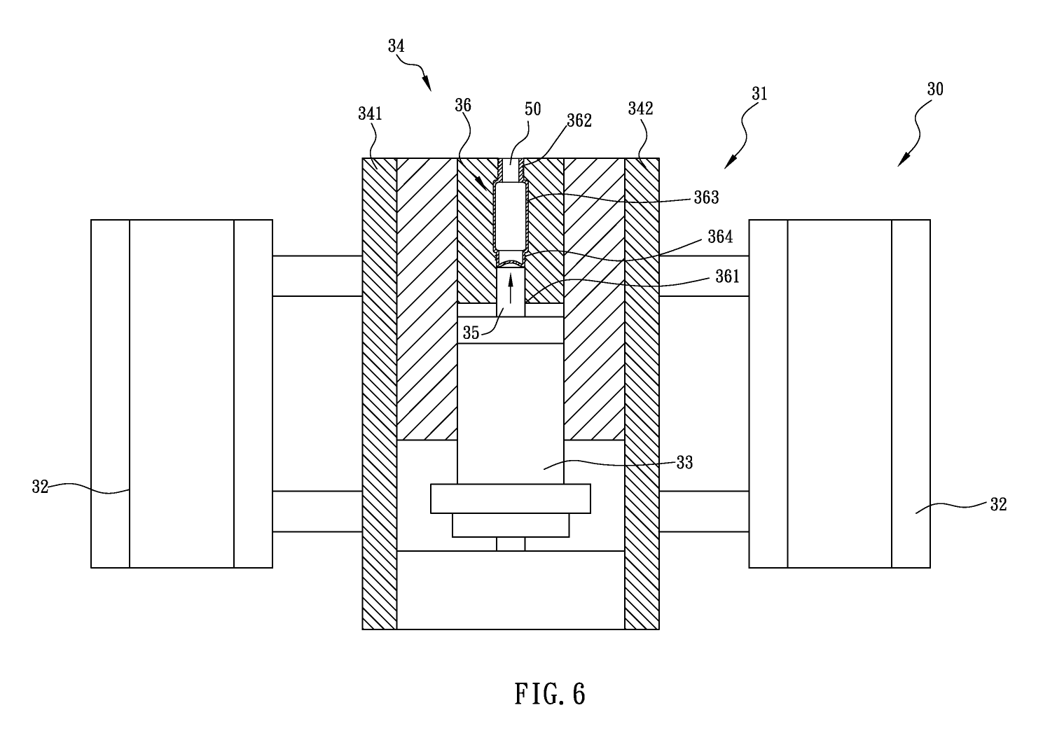

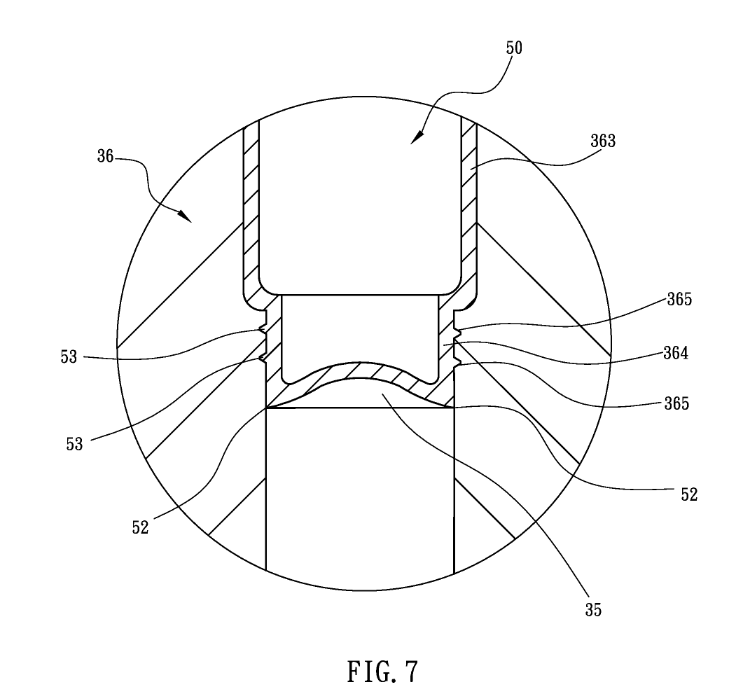

Referring to FIG. 6 and FIG. 7, after the preform 40 is inflated into the semi-finished container 50, the movable block 35 is driven by the second power cylinder 33 to rise from the through hole 361 for pushing the convex bottom 51 upward. As a result, the convex bottom 51 has the material partially pushed backward to form a bottom 52 at the lower end of the container 50. The pressure of the high-pressure gas presented in the container 50 resists the pushed backward material of the convex bottom 51. Thus, the material of the convex bottom 51, under the interaction of the up-going force and the down-going force, is forced to expand into the threading groove 365 and fill the to-be-filled space 37, thereby forming a threaded portion 53 on the container corresponding to the threading groove 365.

From the aforementioned operation it is learned that when the movable block 35 upward pushes the semi-finished container 50, the bottom 52 is formed at the lower end of the finished container 50 with a flat surface or a concave surface. Consequently, the bottom 52 is bordered with the periphery of the finished container 50 by a right-angle or acute-angle connecting rim. Meantime, the threaded portion 53 is formed with even and precise threads. Thus, the finished container 50 is significantly improved in quality and appearance. Besides, the finished container 50 may be further mounted with a decorative cap (not shown) around the bottom 52 in the manner that the threaded portion 53 couples the decorative cap through matching threads and the non-chamfered edge of the bottom 52. The resultant combination is therefore firm and secure against departing under unintentional external force or impact. In virtue of the synergistic effect contributed by the bottom 52 and the threaded portion 53, the finished container 50 and the decorative cap can be combined with enhanced firmness.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A high-pressure bottle-blowing process, comprising steps of:
a. providing at least one preform to a molding device;
b. closing a first mold half and a second mold half of the molding device to form a mold cavity between the first mold half and the second mold half for accommodating the preform therein;
c. providing a high-pressure gas to blow and form the preform into a semi-finished container;
d. pushing a movable block below the mold cavity toward the mold cavity to indent the semi-finished container and form the semi-finished container with a bottom so as to shape a finished container;
e. releasing the finished container from the molding device.

2. The high-pressure bottle-blowing process of claim 1, wherein the preform is heated to a plastic state prior to the step (a).

3. The high-pressure bottle-blowing process of claim 1, wherein the preform of the step (a) has a cap-connecting threaded section and a bottle body while the mold cavity of the step (b) is formed successively a cap-connecting thread corresponding section, a bottle-body receiving section and a thread-forming section from an upper end of the mold cavity, the thread-forming section being provided with at least one threading groove.

4. The high-pressure bottle-blowing process of claim 3, wherein in the step (c), the preform is inflated by the high-pressure gas so that the bottle body is formed conforming to profiles of the bottle-body receiving section and the thread-forming section and a to-be-filled space is left between the bottle body and the threading groove while a convex bottom is formed at a lower end of the semi-finished container.

5. The high-pressure bottle-blowing process of claim 4, wherein in the step (d), the movable block is configured to move vertically in a through hole below the mold cavity so that when rising, the movable block pushes the convex bottom upward to work with the high-pressure gas and make the convex bottom partially extend inward the threading groove, so as to provide the semi-finished container with a threaded portion corresponding to the threading groove.

6. A device of high-pressure bottle blowing, comprising:
a molding device having a mold set and at least one movable block, the mold set including a pair of symmetrical mold halves, namely a first mold half and a second mold half configured to be drawn together and separated, the first mold half having at least one first recess and the second mold half having at least one second recess, so that when the first mold half and the second mold half are drawn together, a mold cavity is defined by the first recess and the second recess between the first mold half and the second mold half for accommodating a preform, and a through hole is provided below the mold cavity for the movable block to move vertically in the through hole; and
a bottle-blowing device for introducing a high-pressure gas into the preform.

7. The device of high-pressure bottle blowing of claim 6, wherein the mold cavity, from an upper end thereof, is formed successively with a cap-connecting thread corresponding section, a bottle-body receiving section and a thread-forming section, in which the thread-forming section is formed with at least one threading groove, and the thread-forming section is intercommunicated with the through hole.

8. The device of high-pressure bottle blowing of claim 6, wherein the first mold half and the second mold half are driven by at least one first power cylinders to be drawn together and separated with respect to each other.

9. The device of high-pressure bottle blowing of claim 6, wherein the movable block is driven by a second power cylinder to move vertically in the through hole.
